(19) United States
(12) Patent Application Publication
(10) Pub. No.: US 2022/0339941 A1
(43) Pub. Date: Oct. 27, 2022

(54) RECORDING APPARATUS

(71) Applicant: Seiko Epson Corporation, Tokyo (JP)

(72) Inventors: Yoshikane TSUCHIHASHI, MATSUMOTO-SHI (JP); Shingo WAKI, MATSUMOTO-SHI (JP)

(21) Appl. No.: 17/659,699

(22) Filed: Apr. 19, 2022

(30) Foreign Application Priority Data
Apr. 22, 2021 (JP) 2021-072716
Apr. 22, 2021 (JP) 2021-072728

(51) Int. Cl. B41J 2/17

(52) U.S. Cl. CPC B41J 2/1721; B41J 2002/1742; B41J 11/007

(57) ABSTRACT

A printer includes a line head and a waste liquid tank. The line head is configured to move in an A direction having a component of a horizontal direction and a component of an apparatus height direction and is configured to eject a liquid onto a sheet to make a record. The liquid ejected from the line head is collected in the waste liquid tank. The waste liquid tank is located below the line head in the Z direction. When viewed in the Z direction from top to bottom, a movement area of the line head and a portion of the waste liquid tank overlap each other over a range defined in the Y direction.

The present application is based on, and claims priority from JP Application Serial Number 2021-072716, filed Apr. 22, 2021 and JP Application Serial Number 2021-072728, filed Apr. 22, 2021, the disclosures of which are hereby incorporated by reference herein in their entirety.

### BACKGROUND

### 1. Technical Field

The present disclosure relates to a recording apparatus.

### 2. Related Art

JP−A-2014-65293 discloses an image forming apparatus that includes an image forming portion including a movable carriage having a recording head. A maintenance unit is disposed below the image forming portion. The maintenance unit has a waste liquid tank.

JP−A-2017-52585 discloses an image forming apparatus in which a second transportation path, a junction of a third transportation path and a re-transportation path, and a paper cassette are located at different positions in the apparatus height direction.

In the configuration of JP−A-2014-65293, the waste liquid tank and the carriage are located at different positions in the apparatus width direction, making the image forming apparatus larger in the apparatus width direction. As seen from this, the recording apparatus including the waste liquid tank and the carriage at different positions in the apparatus width direction may become large in the apparatus width direction.

### SUMMARY

To solve the above-described problems, a recording apparatus according to an aspect of the present disclosure includes a recording portion configured to move in a first movement direction having a component of a horizontal direction and a component of an apparatus height direction and configured to eject a liquid onto a medium to make a record and a collection portion in which the liquid ejected from the recording portion is collected. The collection portion is located below the recording portion in the apparatus height direction. When viewed in the apparatus height direction from top to bottom, a movement area of the recording portion and at least a portion of the collection portion overlap each other over a range defined in an apparatus width direction intersecting the apparatus height direction.

### BRIEF DESCRIPTION OF THE DRAWINGS

FIG. 1 is a view illustrating an overall configuration of a printer according to an embodiment.

FIG. 2 is a view illustrating the inside of the printer according to the embodiment viewed in the apparatus height direction.

FIG. 3 is a magnified view illustrating a portion of the printer according to the embodiment.

FIG. 4 is a view illustrating the inside of the printer according to the embodiment viewed in the apparatus width direction.

FIG. 5 is a view illustrating an overall configuration of a printer according to an embodiment.

FIG. 6 is a magnified view illustrating a portion of the printer according to the embodiment.

FIG. 7 is a magnified view illustrating a portion of the printer according to the embodiment.

FIG. 8 is a magnified view illustrating a portion of the printer according to the embodiment.

FIG. 9 is a view illustrating a first cassette and an input roller of the printer according to the embodiment.

### DESCRIPTION OF EXEMPLARY EMBODIMENTS

Hereinafter, the present disclosure is briefly described. A recording apparatus according to an aspect of the present disclosure includes a recording portion configured to move in a first movement direction having a component of a horizontal direction and a component of an apparatus height direction and configured to eject a liquid onto a medium to make a record and a collection portion in which the liquid ejected from the recording portion is collected. The collection portion is located below the recording portion in the apparatus height direction. When viewed in the apparatus height direction from top to bottom, a movement area of the recording portion and at least a portion of the collection portion overlap each other over a range defined in an apparatus width direction intersecting the apparatus height direction. For this configuration, when viewed in the apparatus height direction from top to bottom, the movement area and at least a portion of the collection portion overlap each other over a range defined in the apparatus width direction, making the recording apparatus smaller in the apparatus width direction than a configuration in which the movement area and the collection portion do not overlap each other over a range defined in the apparatus width direction.

The recording apparatus may further include a maintenance portion configured to move in a second movement direction intersecting the first movement direction and configured to perform maintenance of the recording portion. The maintenance portion may be located below the recording portion in the apparatus height direction, and at least a portion of the collection portion may overlap, when viewed in the apparatus width direction, the maintenance portion over a range defined in the apparatus height direction. For this configuration, the recording apparatus has a lower height than a configuration in which, when viewed in the apparatus width direction, the collection portion and the maintenance portion do not overlap each other over a range defined in the apparatus height direction.

The recording apparatus may further include a movement portion configured to move the recording portion in the first movement direction. At least a portion of the movement portion may be located below the movement area and above the collection portion in the apparatus height direction. For this configuration, a space between the movement area and the collection portion in the apparatus height direction is effectively used as an installation space for the movement portion, reducing the possibility that the recording apparatus will become large in the apparatus height direction.

The recording apparatus may further include a supplier configured to supply the liquid to the recording portion. When viewed in the apparatus width direction, at least a portion of the supplier and at least a portion of the collection portion may overlap each other over a range defined in the apparatus height direction. For this configuration, the recording apparatus has a lower height than a configuration in which, when viewed in the apparatus width direction, the supplier and the collection portion do not overlap each other over a range defined in the apparatus height direction.

In the recording apparatus, at least a portion of the supplier may overlap, when viewed in the apparatus width direction, at least a portion of the movement area over a range defined in the apparatus height direction. For this configuration, the recording apparatus has a lower height than a configuration in which, when viewed in the apparatus width direction, supplier and the movement area do not overlap each other over a range defined in the apparatus height direction.

The recording apparatus may further include a transportation belt placed opposite to the recording portion and configured to transport the medium. At least a portion of the transportation belt may overlap, when viewed in the apparatus width direction, at least a portion of the supplier over a range defined in the apparatus height direction. For this configuration, the recording apparatus has a lower height than a configuration in which, when viewed in the apparatus width direction, the supplier and the transportation belt do not overlap each other over a range defined in the apparatus height direction.

The recording apparatus may further include a receptacle portion configured to receive the medium after recording by the recording portion and extending in the first movement direction. When viewed in the apparatus height direction from top to bottom, at least a portion of the receptacle portion and at least a portion of the movement area may overlap each other over a range defined in the apparatus width direction. For this configuration, the recording apparatus is smaller in the apparatus width direction than a configuration in which, when viewed in the apparatus height direction, the receptacle portion and the movement area do not overlap each other over a range defined in the apparatus width direction. Furthermore, an unwanted space is less likely to be formed between the receptacle portion and the movement area because the receptacle portion extends in the first movement direction.

In the recording apparatus, the collection portion may be configured to be detached in an intersecting direction intersecting the apparatus width direction. For this configuration, the recording apparatus has less components in an attachment and detachment path of the collection portion than a configuration in which the collection portion is attached and detached in the apparatus height direction, allowing easy removal of the collection portion.

The recording apparatus may further include at least one medium storage configured to store a medium, a transportation path located above the medium storage in the apparatus height direction and along which the medium is transported from the medium storage to the recording portion, an inversion portion including an inversion pathway having a curved path that protrudes downward in the apparatus height direction and coupled to the transportation path at positions upstream and downstream of the recording portion, and an input portion including an input pathway coupled to a portion of the transportation path located upstream of the recording portion and configured to feed the medium from the input pathway to the transportation path. The inversion portion is configured to invert the medium after recording by the recording portion. When viewed in the apparatus width direction, at least a portion of the input portion, at least a portion of the curved path, and at least a portion of the medium storage may overlap each other over a range defined in the apparatus height direction. For this configuration, when viewed in the apparatus width direction, at least a portion of the input portion, at least a portion of the curved path, and at least a portion of the medium storage overlap each other over a range defined in the apparatus height direction. This configuration requires a smaller installation space for the input portion, the curved path, and the medium storage in the apparatus height direction than a configuration in which the input portion, the curved path, and the medium storage do not overlap each other, reducing the height of the recording apparatus.

In the recording apparatus, the medium storage may include a first storage having a first length in the apparatus width direction and a second storage located below the first storage in the apparatus height direction and having a second length larger than the first length in the apparatus width direction, and at least one of at least a portion of the curved path and at least a portion of the input portion is located outwardly from the first storage in the apparatus width direction and above the second storage in the apparatus height direction. This configuration requires a smaller installation space for the input portion and the curved path than a configuration in which a portion of the curved path or a portion of the input portion is not located in the area located outwardly from the first storage in the apparatus width direction and above the second storage in the apparatus height direction, reducing the height of the recording apparatus.

In the recording apparatus, a feeding pathway may extend from the second storage to the curved path. The input pathway and the feeding pathway joined together may be coupled to the curved path, and a meeting portion where the input pathway and the feeding pathway join together may overlap, when viewed in the apparatus width direction, a portion of the first storage over a range defined in the apparatus height direction. For this configuration, a portion of the input pathway and a portion of the feeding pathway are combined into one. This configuration requires a smaller number of components constituting the transportation path along which the medium is transported than a configuration in which the input pathway and the feeding pathway separately join the curved path. Furthermore, this configuration requires a smaller installation space for the meeting portion and the first storage than a configuration in which the meeting portion and the first storage do not overlap each other over a range defined in the apparatus height direction, reducing the height of the recording apparatus.

In the recording apparatus, the input portion may include an input roller configured to send the medium to the transportation path. When viewed in the apparatus width direction, at least a portion of the input roller, at least a portion of the curved path, and at least a portion of the medium storage may overlap each other over a range defined in the apparatus height direction. For this configuration, when viewed in the apparatus width direction, at least a portion of the input roller, at least a portion of the curved path, and at least a portion of the medium storage overlap each other over a range defined in the apparatus height direction. This configuration requires a smaller installation space for the input roller, the curved path, and the medium storage in the apparatus height direction than a configuration in which the input roller, the curved path, and the medium storage do not overlap each other over a range defined in the apparatus height direction, reducing the height of the recording apparatus.

In the recording apparatus, the input portion may include an input tray on which multiple sheets of the medium are placed and a separation roller configured to separate one from the multiple sheets of the medium on the input tray, and when viewed in the apparatus width direction, the separation roller and at least a portion of the medium storage may overlap each other over a range defined in the apparatus height direction. For this configuration, when viewed in the apparatus width direction, the separation roller and at least a portion of the medium storage overlap each other over a range defined in the apparatus height direction. This requires a smaller installation space for the separation roller and the medium storage than a configuration in which the separation roller and the medium storage do not overlap each other, reducing the height of the recording apparatus.

In the recording apparatus, the inversion portion may further include an upstream path located upstream of the curved path in a transportation direction of the medium, the upstream path may include a tilted portion tilted in an intersecting direction intersecting the apparatus height direction, and when viewed in the apparatus height direction from top to bottom, at least a portion of the tilted portion and at least a portion of the input portion may overlap each other over a range defined in the apparatus width direction. For this configuration, the tilted portion of the upstream path provides a space in which at least a portion of the input portion is disposed, making the width of the recording apparatus smaller than a configuration in which the portion of the upstream path extends in the apparatus width direction.

In the recording apparatus, the curved path may include a transportation roller pair configured to transport the medium, and when viewed in the apparatus width direction, at least a portion of the input portion and at least a portion of the transportation roller pair may overlap each other over a range defined in the apparatus height direction. For this configuration, the curved path includes a transportation roller pair configured to transport the medium, allowing the medium to be more reliably transported along the curved path than a configuration not having the transportation roller pair. Furthermore, when viewed in the apparatus width direction, at least a portion of the input portion and at least a portion of the transportation roller pair overlap each other over a range defined in the apparatus height direction, reducing the height of the recording apparatus.

In the recording apparatus, the first movement direction and the apparatus width direction may form an angle of not less than 10° and not more than 40°. For this configuration, the recording apparatus has a smaller movement area of the recording portion in the apparatus width direction than a configuration in which an angle between the first movement direction and the apparatus width direction is smaller than 10°, reducing the width of the recording apparatus.

### 1. First Embodiment

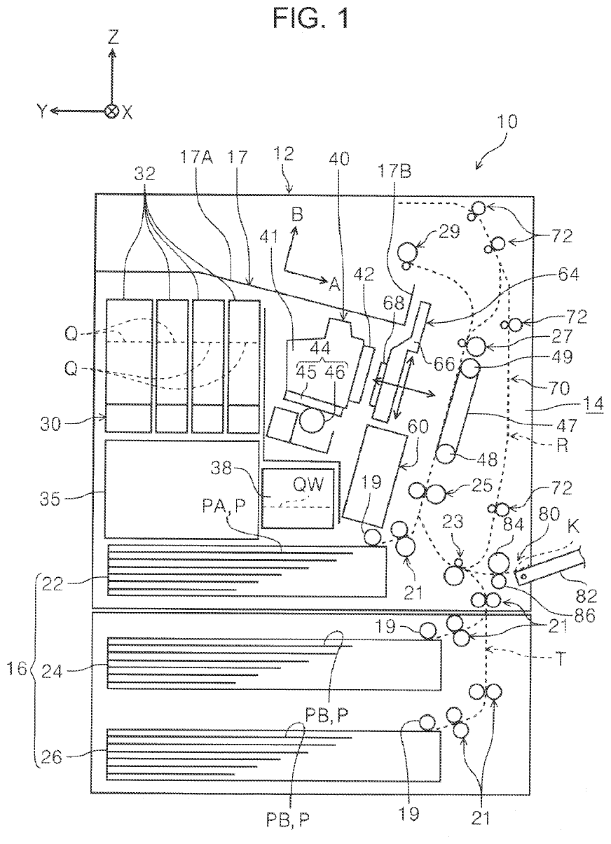

Hereinafter, a printer 10 as an example of a recording apparatus according to the present disclosure will be described in detail. As illustrated in FIG. 1, the printer 10 is an example of a recording apparatus that ejects an ink Q to a sheet P to make a record. In the drawings, the X−Y−Z coordinate system is a Cartesian coordinate system. The sheet P is an example of a medium. The ink Q is an example of a liquid.

The X direction corresponds to the apparatus depth direction and corresponds to the horizontal direction. The X direction includes a -X direction pointed by the tail of the arrow and a +X direction pointed by the head of the arrow. The X direction also corresponds to the width direction of the sheet P. The Y direction is an example of the apparatus width direction and corresponds to the horizontal direction. The Y direction includes a +Y direction pointed by the head of the arrow and a −Y direction pointed by the tail of the arrow. The Z direction is an example of the apparatus height direction and corresponds to a direction perpendicular to both the X direction and the Y direction. The Z direction includes a +Z direction pointed by the head of the arrow and a −Z direction pointed by the tail of the arrow. In the following description, the +Z direction may be referred to as “above” and the −Z direction may be referred to as “below”.

When viewed in the X direction, an A direction is an oblique direction intersecting the Y direction and is tilted such that the −Y direction side is positioned lower in the −Z direction than the +Y direction side. In other words, the A direction is an example of a first movement direction having a component of the horizontal direction and a component of the apparatus height direction. The A direction includes a +A direction pointed by the head of the arrow and a −A direction pointed by the tail of the arrow. The +A direction is a direction in which a line head 40 (described later) moves toward a transportation belt 47. The −A direction is a direction in which the line head 40 moves away from the transportation belt 47.

When viewed in the X direction, a B direction is a direction perpendicular to the A direction. In other words, the B direction is an example of a second movement direction intersecting the A direction. The B direction includes a +B direction pointed by the head of the arrow and a −B direction pointed by the tail of the arrow. The +B direction is a transportation direction in which the sheet P is transported in a recording area defined between the line head 40 and the transportation belt 47.

The printer 10 has a transportation path T indicated by a broken line in the apparatus body 12. The sheet P is transported along the transportation path T. The transportation direction of the sheet P extends along the transportation path T and thus varies depending on the section of the transportation path T. A sheet PA and a sheet PB that have different lengths in the transportation direction are examples of the sheet P used in the printer 10. The sheet PA is shorter than the sheet PB in the transportation direction.

The printer 10 includes an apparatus body 12, a paper cassette 16 disposed in the apparatus body 12, a line head 40, and a waste liquid tank 38. The printer 10 further includes a sheet output tray 17, an ink supplier 30, a transportation belt 47, a cap portion 60, a wiper portion 64, a movement portion 44, an inversion portion 70, an input portion 80, and a controller (not illustrated). The apparatus body 12 has a housing that forms an outer shape of the apparatus body 12. The apparatus body 12 has an opening 14 opening in the Y direction at the end in the −Y direction. A portion of the transportation path T (described later) is exposed to the outside when the opening 14 is uncovered.

The paper cassette 16 stores the sheet P. The paper cassette 16 includes, for example, first, second, and third cassettes 22, 24, and 26. Examples of the sheets P used in the printer 10 include the sheet PA and the sheet PB larger than the sheet PA. The first cassette 22 stores the sheet PA. The second and third cassettes 24 and 26 each store the sheet PB. The sheet P is sent to the transportation path T when a pick-up roller 19 and a roller pair 21 are rotated.

The sheet output tray 17 is located away in the +Z direction from the center in the Z direction of the apparatus body 12. The sheet output tray 17 is an example of a receptacle portion that receives the discharged sheet P after recording by the line head 40. The sheet output tray 17 has a bottom wall 17A extending in the A direction and a vertical wall 17B extending in the +B direction from the end in the +A direction of the bottom wall 17A, for example. The sheets P are stacked on top of another in the +B direction on the bottom wall 17A. The edges of the sheets P in the +A direction are in contact with the vertical wall 17B so as to be lined up in the B direction.

The transportation path T extends from the paper cassette 16 to the sheet output tray 17 and is a path along which the sheet P is transported. The pick-up roller 19, the roller pairs 21, 23, and 25, the transportation belt 47, a drive roller 48, a driven roller 49, a roller pair 27, and an output roller pair 29 are disposed on the transportation path T. The roller pairs are rotatable about the axes extending in the X direction. The drive roller 48 and the driven roller 49 are located away from each other in the B direction and are rotatable about the axes extending in the X direction. The drive roller 48 is rotated by a motor (not illustrated).

The transportation belt 47 is wound into a tubular configuration on the drive roller 48 and the driven roller 49. The transportation belt 47 is adjacent to the line head 40 in the +A direction. When the drive roller 48 is rotated by a motor (not illustrated), the transportation belt 47 is rotated. When the transportation belt 47 is rotated, the sheet P on the outer surface of the transportation belt 47 is transported in the +B direction. In this way, the transportation belt 47 placed opposite to the line head 40 transports the sheet P.

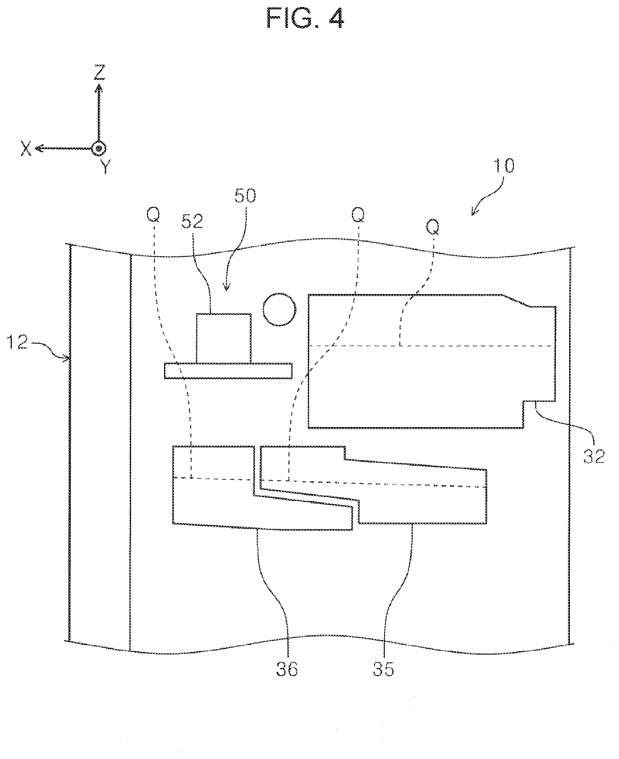

The ink supplier 30 is an example of a supplier that supplies the ink Q to the line head 40 (described later). Specifically described, the ink supplier 30 includes four ink cartridges 32, a sub tank 35, a reservoir tank 36, a transport portion 50 (FIG. 4), and tubes (not illustrated) coupling the components. The four ink cartridges 32 contain different colors of inks Q.

As illustrated in FIG. 4, when viewed in the Y direction, the ink cartridge 32 is located away in the −X direction and the +Z direction from the center of the apparatus body 12. The sub tank 35 is adjacent to the ink cartridge 32 in the −Z direction. The sub tank 35 is a tank that temporary stores the ink Q supplied from the ink cartridge 32. The ink Q in the sub tank 35 is supplied to an ejection portion 42 (FIG. 1) (described later). The reservoir tank 36 is adjacent to the sub tank 35 in the +X direction. The reservoir tank 36 stores the ink Q as the sub tank 35 does. The reservoir tank 36 is used to keep the meniscus of the ejection portion 42 of the line head 40 (FIG. 1) (described later).

In the apparatus body 12, the transport portion 50 is adjacent to the ink cartridge 32 in the +X direction and to the reservoir tank 36 in the +Z direction. The transport portion 50 includes a switching valve 52 and a pump motor (not illustrated). The transport portion 50 transports the ink Q in the sub tank 35 and the ink Q in the reservoir tank 36 to the line head 40 (FIG. 1) by using a tube and a pump (not illustrated).

As illustrated in FIG. 1, the waste ink QW sent from the cap portion 60 and the waste ink QW sent from the wiper portion 64 are transported by the transport portion 50 (FIG. 4) to the waste liquid tank 38 (described later). The waste liquid tank 38 is located at substantially the center in the Y direction and the Z direction of the apparatus body 12 and is replaceable. The waste liquid tank 38 is located below the line head 40 (described later) in the Z direction. The waste liquid tank 38 is an example of a collection portion in which the ink Q ejected from the line head 40 is collected. The ink Q ejected from the line head 40 means the ink Q ejected from the line head 40 but not attached to the sheet P and not used in the recording. In other words, the ink Q ejected from the line head 40 is the waste ink QW. The waste liquid tank 38 stores the ink Q collected at the cap portion 60 and the ink Q collected at the wiper portion 34 as described above. The waste ink QW may include the waste ink generated during wiping by the wiper portion 64 and maintenance by the cap portion 60.

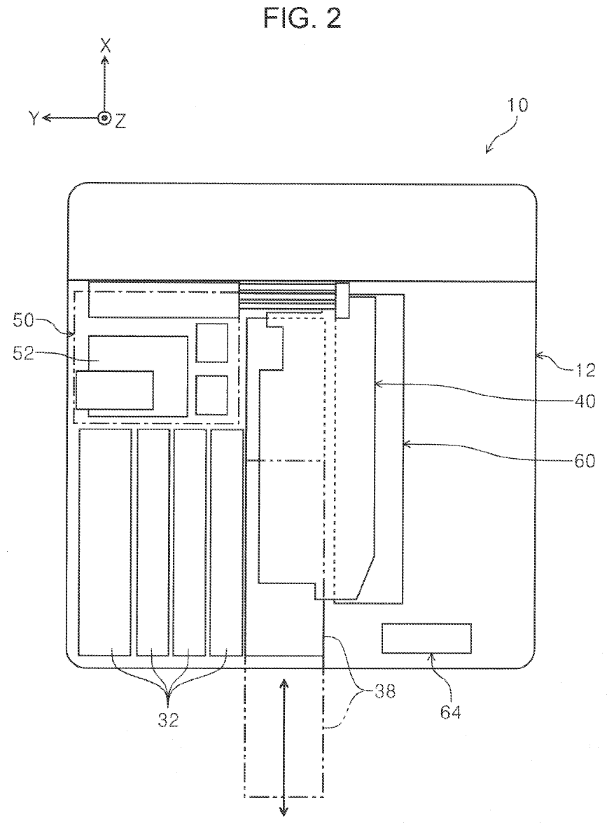

As illustrated in FIG. 2, when viewed in the Z direction, the waste liquid tank 38 is detachable in the X direction, which is an example of an intersecting direction intersecting the Y direction. Specifically described, the waste liquid tank 38 is moved in the −X direction to be detached from the apparatus body 12. The waste liquid tank 38 is moved in the +X direction relative to the apparatus body 12 to be attached to the apparatus body 12. Furthermore, when viewed in the Z direction, the ink cartridge 32, the first cassette 22, the second cassette 24, and the third cassette 26 are detachable in the X direction, which is an example of the intersecting direction intersecting the Y direction.

As illustrated in FIG. 1, the line head 40 is positioned at the home position before operation. The home position of the line head 40 in the apparatus body 12 is, for example, located away from the ink cartridge 32 in the −Y direction, located below the sheet output tray 17 in the Z direction, and located above the paper cassette 16 and the waste liquid tank 38 in the Z direction.

The line head 40 is an example of a recording portion that ejects the ink Q onto the sheet P being transported from the paper cassette 16 along the transportation path T to make a record. The line head 40 is movable in the +A direction and the −A direction, or the A direction, when driven by a movement portion 44 (described later). Specifically described, the line head 40 includes the carriage 41 driven by the movement portion 44 and the ejection portion 42 supported by the carriage 41. The ejection portion 42 has multiple nozzles (not illustrated) and ejects the ink Q fed from the ink supplier 30 to the sheet P.

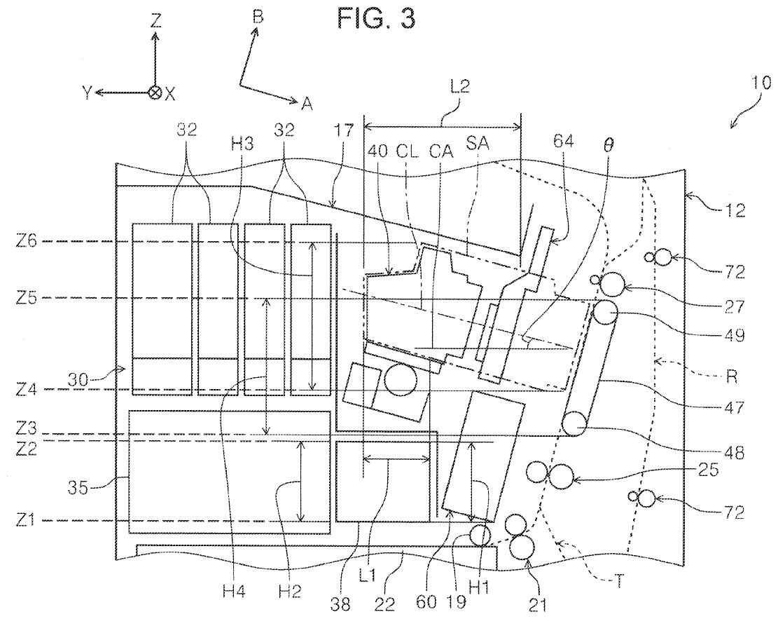

The movement portion 44 is a mechanism that moves the line head 40 in the A direction. The movement portion 44 is located below a movement area SA (FIG. 3) (described later) and above the waste liquid tank 38 in the Z direction. The movement portion 44 includes, for example, a rack 45, a pinion 46, and a motor (not illustrated). The rack 45 is attached to the bottom surface of the carriage 41 facing in the −Z direction. The rack 45 has teeth (not illustrated). The pinion 46 is rotated in a normal direction or an opposite direction by a motor (not illustrated). The pinion 46 has teeth (not illustrated) engaging the teeth of the rack 45 on the outer surface.

The cap portion 60 is reciprocated in the B direction when driven by a drive mechanism (not illustrated). The cap portion 60 is an example of a maintenance portion that performs maintenance of the line head 40. The cap portion 60 at the home position is located below the line head 40 in the Z direction. When viewed in the X direction, the home position of the cap portion 60 is away from the wiper portion 64 in the −B direction.

The cap portion 60 has a box-like shape opening in the −A direction. In the maintenance of the line head 40, the cap portion 60 is moved in the +B direction to cover the ejection portion 42 and then removes the ink Q by suction from the ejection portion 42. The cap portion 60 is moved back to the home position when the line head 40 performs recording.

The wiper portion 64 includes a unit body 66 that can store the ink Q and a wiper blade 68 that is disposed on the unit body 66 and configured to wipe the ink Q from the ejection portion 42. The wiper portion 64 is reciprocated in the X direction when driven by a drive mechanism (not illustrated). In the maintenance of the line head 40, the wiper portion 64 wipes the surface of the ejection portion 42 while being moved in the +X direction to collect the ink Q. The wiper portion 64 is moved back in the −X direction to the home position when the line head 40 performs recording.

The controller (not illustrated) includes a central processing unit (CPU), read-only memory (ROM), random-access memory (RAM), and a storage (not illustrated), to control transportation of the sheet P in the printer 10 and operations of the components including the line head 40.

The inversion portion 70 includes, for example, an inversion pathway R, four roller pairs 72, and a motor (not illustrated) that drives the four roller pairs 72. The inversion portion 70 inverts the sheet P after recording by the line head 40 and then sends the sheet P to the transportation path T again.

The input portion 80 includes, for example, an input tray 82, an input roller 84, and a separation roller 86. The input portion 80 includes an input pathway K on which the input roller 84 and the separation roller 86 are disposed. The input portion 80 sends the sheet P from the input tray 82 to the transportation path T through the input pathway K.

As illustrated in FIG. 3, an area where the line head 40 moves during reciprocation of the line head 40 in the A direction is referred to as a movement area SA of the line head 40. The movement area SA is outlined by a two-dot chain line SA. The line extending in the A direction through the center of the line head 40 is a center line CL indicated by a one-dot chain line CL. The angle θ between the one-dot chain line CL and a line segment CA extending in the Y direction is preferably not less than 10° and not more than 40°. In other words, the angle θ between the A direction and the Y direction is preferably not less than 10° and not more than 40°. In this embodiment, the angle θ is about 15°, for example.

When viewed in the Z direction, the movement area SA of the line head 40 and a portion of the waste liquid tank 38 overlap each other over a range defined in the Y direction. The overlap between the movement area SA and a portion of the waste liquid tank 38 extends in a range L1 [mm] defined in the Y direction. In this embodiment, “when viewed in the Z direction” means when an object is viewed in the Z direction from the +Z direction side of the printer 10 toward the −Z direction side. In other words, “when viewed in the Z direction” means when the printer 10 is viewed from the +Z direction side toward the −Z direction side through the top surface, or viewed in top view. When the line head 40 at the home position is viewed in the Z direction, a portion of the line head 40 and a portion of the waste liquid tank 38 overlap each other over the range L1 defined in the Y direction.

When viewed in the Y direction, a portion of the waste liquid tank 38 overlaps the cap portion 60 over a range defined in the Z direction. The overlap between a portion of the waste liquid tank 38 and a portion of the cap portion 60 extends in a range H1 [mm] defined in the Z direction. The lower end of the range H1 corresponds to, for example, a position Z1, which is the lower end of the waste liquid tank 38 in the Z direction. The upper end of the range H1 corresponds to, for example, a position Z2, which is the upper end of the waste liquid tank 38 in the Z direction.

In this embodiment, “when viewed in the Y direction” means when an object is viewed in the Y direction from the +Y direction side of the printer 10 toward the −Y direction side or from the −Y direction side of the printer 10 toward the +Y direction side. In other words, “when viewed in the Y direction” means when the printer 10 is viewed from the +Y direction side toward the −Y direction side or from the −Y direction side toward the +Y direction side through the side surface, or viewed in side view.

When viewed in the Y direction, a portion of the ink supplier 30 and the waste liquid tank 38 overlap each other over a range defined in the Z direction. The overlap between a portion of the ink supplier 30 and the waste liquid tank 38 extends in a range H2 [mm] defined in the Z direction. The lower end of the range H2 corresponds to, for example, the above-described position Z1. The upper end of the range H2 corresponds to, for example, the above-described position Z2. In an example of this embodiment, the lower end of the range H1 and the lower end of the range H2 are located at substantially the same height position in the Z direction, for example. Furthermore, in an example of the present embodiment, the range H1 and the range H2 are substantially the same.

When viewed in the Y direction, a portion of the ink supplier 30 overlaps the movement area SA over a range defined in the Z direction. The overlap between a portion of the ink supplier 30 and the movement area SA extends in a range H3 [mm] defined in the Z direction. The lower end of the range H3 corresponds to, for example, a position Z4, which is the lower end of the movement area SA in the Z direction. The upper end of the range H3 corresponds to, for example, a position Z6, which is the upper end of the movement area SA in the Z direction. The range H3 is larger than each of the range H1 and the range H2, for example.

When viewed in the Y direction, the transportation belt 47 overlaps a portion of the ink supplier 30 over a range defined in the Z direction. The overlap between the transportation belt 47 and the ink supplier 30 extends in a range H4 [mm] defined in the Z direction. The lower end of the range H4 corresponds to, for example, a position Z3, which is the lower end of the transportation belt 47 in the Z direction. The upper end of the range H4 corresponds to, for example, a position Z5, which is the upper end of the transportation belt 47 in the Z direction. For the Z1, Z2, Z3, Z4, Z5, and Z6, the higher the numbers next to “Z” are, the higher the position is. The range H4 is smaller than the range H3, for example. When viewed in the Z direction, a portion of the sheet output tray 17 and a portion of the movement area SA overlap each other over a range defined in the Y direction. The overlap between a portion of the sheet output tray 17 and a portion of the movement area SA extends in a range L2 [mm] defined in the Y direction. The range L2 is larger than the range L1.

Next, the operation of the printer 10 will be described. FIGS. 1 to 4 are referred for the components of the printer 10 without identification of the individual figure numbers. For the printer 10, when viewed in the Z direction, the movement area SA and a portion of the waste liquid tank 38 overlap each other over a range defined in the Y direction, making the printer 10 smaller in the Y direction than a configuration in which the movement area SA and the waste liquid tank 38 do not overlap each other over a range defined in the Y direction.

For the printer 10, the printer 10 has a lower height than a configuration in which, when viewed in the Y direction, the waste liquid tank 38 and the cap portion 60 do not overlap each other over a range defined in the Z direction. For the printer 10, a space between the movement area SA and the waste liquid tank 38 in the Z direction is effectively used as an installation space for the movement portion 44, reducing the possibility that the printer 10 will be larger in the Z direction.

For the printer 10, the printer 10 has a lower height than a configuration in which, when viewed in the Y direction, the ink supplier 30 and the waste liquid tank 38 do not overlap each other over a range defined in the Z direction. For the printer 10, the printer 10 has a lower height than a configuration in which, when viewed in the Y direction, the ink supplier 30 and the movement area SA do not overlap each other over a range defined in the Z direction.

For the printer 10, the printer 10 has a lower height than a configuration in which, when viewed in the Y direction, the ink supplier 30 and the transportation belt 47 do not overlap each other over a range defined in the Z direction. For the printer 10, the printer 10 is smaller in the Y direction than a configuration in which, when viewed in the Z direction, the sheet output tray 17 and the movement area SA do not overlap each other over a range defined in the Y direction. Furthermore, an unwanted space is less likely to be formed between the sheet output tray 17 and the movement area SA because the sheet output tray 17 extends in the A direction in the first movement direction.

For the printer 10, the printer 10 has a smaller movement area SA of the line head 40 in the Y direction than a configuration in which an angle between the A direction and the Y direction is smaller than 10°, reducing the width of the printer 10 in the Y direction. With the above-described configuration, the space required for the movement of the line head 40 keeps a balance between the size in the horizontal direction and the size in the vertical direction, reducing the possibility that the apparatus will excessively become large in the horizontal direction and the vertical direction. For the printer 10, the printer 10 has less components in an attachment and detachment path of the waste liquid tank 38 than a configuration in which the waste liquid tank 38 is attached and detached in the Z direction, allowing easy removal of the waste liquid tank 38.

The printer 10 according to the first embodiment of the present disclosure basically has the above-described configuration. However, the configuration of the printer 10 may be partly modified or partly omitted without departing from the gist of the present disclosure.

When the printer 10 is viewed in the Z direction, the movement area SA and the entire waste liquid tank 38 may overlap each other. When viewed in the Y direction, the entire waste liquid tank 38 may overlap the cap portion 60. A portion of the movement portion 44 may be located below the movement area SA and above the waste liquid tank 38 in the Z direction. When viewed in the Y direction, the entire ink supplier 30 and the waste liquid tank 38 may overlap each other over a range defined in the Z direction.

In the printer 10, when viewed in the Y direction, a portion of the ink supplier 30 may overlap a portion of the movement area SA over a range defined in the Z direction. Furthermore, when viewed in the Y direction, the entire ink supplier 30 may overlap the entire movement area SA over a range defined in the Z direction. When viewed in the Y direction, a portion of the transportation belt 47 may overlap a portion of the ink supplier 30 over a range defined in the Z direction. Furthermore, when viewed in the Y direction, the entire transportation belt 47 may overlap the entire ink supplier 30 over a range defined in the Z direction. When viewed in the Z direction, a portion of the sheet output tray 17 and the entire movement area SA, or the entire sheet output tray 17 and a portion of the movement area SA, may overlap each other over a range defined in the Y direction. Alternatively, when viewed in the Z direction, the entire sheet output tray 17 and the entire movement area SA may overlap each other over a range defined in the Y direction.

In the printer 10, when viewed in the Y direction, a portion of the waste liquid tank 38 does not need to overlap the cap portion 60 over a range defined in the Z direction. The movement portion 44 does not need to be disposed below the movement area SA and above the waste liquid tank 38. In such a case, for the printer 10, when viewed in the Y direction, a portion of the waste liquid tank 38 may overlap the movement area SA over a range defined in the Z direction. For example, when viewed in the Y direction, a portion of the waste liquid tank 38 may overlap the line head 40 positioned at the recording position over a range defined in the Z direction. When viewed in the Y direction, a portion of the ink supplier 30 and the waste liquid tank 38 do not need to overlap each other over a range defined in the Z direction. A portion of the ink supplier 30 does not need to overlap the movement area SA over a range defined in the Z direction.

In the printer 10, when viewed in the Y direction, the transportation belt 47 does not need to overlap a portion of the ink supplier 30 over a range defined in the Z direction. When viewed in the Z direction, a portion of the sheet output tray 17 and a portion of the movement area SA do not need to overlap each other over a range defined in the Y direction. The angle θ is preferably not less than 10° and not more than 40°. This configuration provides the space required for the movement of the line head 40 and provides the installation space for the waste liquid tank 38 below the line head 40 in the Z direction, reducing the size of the printer 10 in the Y direction. The angle θ may be more than 0° and less than 10°. Furthermore, the angle θ may be more than 40° and not more than 80°. The waste liquid tank 38 does not need to be detachable in the X direction. The collection portion is not limited to a tank-like member as the waste liquid tank 38 and may be an open box-like member or a dish-like member.

As illustrated in FIG. 3, when the line head 40 is positioned at the end of the movement area SA in the +Y direction, the line head 40 can be pulled upward out of the printer 10. This enables replacement of the line head 40. Hereinafter, the end in the +Y direction of the movement area SA is referred to as a replacement position of the line head 40. The sheet output tray 17 is detachable from the apparatus body 12. When the sheet output tray 17 is detached, the line head 40 at the replacement position is exposed, enabling removal and replacement of the line head 40. The ink Q may flow down from the line head 40 during replacement of the line head 40. However, as illustrated in FIG. 3, the waste liquid tank 38 is located directly below the line head 40 positioned at the replacement position. In this configuration, the ink Q falling down from the line head 40 is received by the waste liquid tank 38 and collected. For example, the waste liquid tank 38 may have a tray-like shaped top having a hole through which the ink Q is introduced into the waste liquid tank 38. This configuration enables the ink Q falling down from the line head 40 to be collected in the waste liquid tank 38.

### 2. Second Embodiment

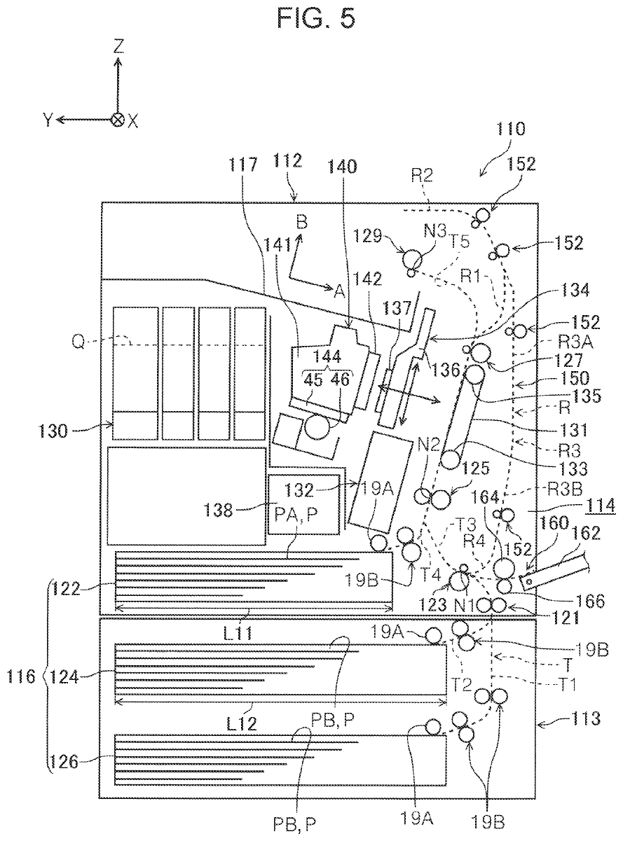

Hereinafter, a printer 110 as an example of a recording apparatus according to the present disclosure will be described in detail. As illustrated in FIG. 5, the printer 110 is an example of a recording apparatus that ejects an ink Q onto a sheet P to make a record. In the drawings, the X-Y-Z coordinate system is a Cartesian coordinate system. The sheet P is an example of a medium. The ink Q is an example of a liquid.

The X direction corresponds to the horizontal direction. The X direction includes a -X direction pointed by the tail of the arrow and a +X direction pointed by the head of the arrow. The X direction also corresponds to the width direction of the sheet P. The Y direction is an example of the apparatus width direction and corresponds to the depth direction of the printer 110 and the horizontal direction. The Y direction includes a +Y direction pointed by the head of the arrow and a −Y direction pointed by the tail of the arrow. The Z direction is an example of the apparatus height direction and corresponds to a direction perpendicular to both the X direction and the Y direction. The Z direction includes a +Z direction pointed by the head of the arrow and a −Z direction pointed by the tail of the arrow. In the following description, the +Z direction may be referred to as “above” and the −Z direction may be referred to as “below”.

When viewed in the X direction, an A direction is an oblique direction intersecting the Y direction and is tilted such that the −Y direction side is positioned lower in the −Z direction than the +Y direction side. The A direction includes a +A direction pointed by the head of the arrow and a −A direction pointed by the tail of the arrow. The +A direction is a direction in which a line head 140 (described later) moves toward a transportation belt 131. The −A direction is a direction in which the line head 140 moves away from the transportation belt 131. When viewed in the X direction, the B direction is a direction perpendicular to the A direction. The B direction includes a +B direction pointed by the head of the arrow and a −B direction pointed by the tail of the arrow. The +B direction is a transportation direction of the sheet P in a recording area defined between the line head 140 and the transportation belt 131.

In the printer 110, the sheet P is transported along the transportation path T indicated by a broken line. The travelling direction of the sheet P extends along the transportation path T and thus varies depending on the section of the transportation path T. The transportation direction of the sheet P is referred to as “downstream” and the opposite direction is referred to as “upstream” in some cases. A sheet PA and a sheet PB that have different lengths in the transportation direction are examples of the sheet P used in the printer 110. The sheet PA is shorter than the sheet PB in the transportation direction.

The printer 110 includes, for example, a main unit 112 and an additional unit 113 disposed below the main unit 112. Specifically described, the printer 110 includes a paper cassette 116, a line head 140, an inversion portion 150, and an input portion 160. Furthermore, the printer 110 includes an ink supplier 130, a cap portion 132, a wiper portion 134, a waste liquid tank 138, and a controller (not illustrated).

The main unit 112 has a housing that forms an outer shape of the main unit 112. The main unit 112 has an output tray 117 at a position away in the +Z direction from the center in the Z direction. The main unit 112 and the additional unit 113 have the paper cassette 116. The main unit 112 has an opening 114 opening in the Y direction at the end in the −Y direction. The transportation path T (described later) is exposed when the opening 114 is uncovered.

The additional unit 113 has a housing that forms an outer shape of the additional unit 113. The additional unit 113 is detachable from the main unit 112. The upper end in the +Z direction of the additional unit 113 and the lower end in the −Z direction of the main unit 112 are coupled to each other, enabling transportation of the sheet P from the additional unit 113 to the main unit 112. The sheet output tray 117 is a component that receives the sheets P after recording by the line head 140. The sheet output tray 117 extends, for example, in the A direction. On the sheet output tray 117, the ends in the +A direction of the sheets P are lined up in the B direction.

The paper cassette 116 is an example of at least one medium storage that stores the sheet P. The paper cassette 116 includes, for example, a first cassette 122 in the main unit 112 and a second cassette 124 and a third cassette 126 in the additional unit 113. The first cassette 122 is an example of a first storage that stores the sheet PA. The first cassette 122 has a cuboidal box-like shape opening in the +Z direction. The first cassette 122 has a first length L11 [mm] in the Y direction. The sheet P in the first cassette 122 is sent to the transportation path T when a pick-up roller 19A and a roller pair 19B are rotated.

The second cassette 124 is an example of a second storage that stores the sheet PB. The second cassette 124 is located below the first cassette 122 in the Z direction. The second cassette 124 has a cuboidal box-like shape opening in the +Z direction. The second cassette 124 has a second length L12 [mm] in the Y direction. The second length L12 is longer than the first length L11. The second cassette 124 is longer than the first cassette 122 in the X direction. The sheet P in the second cassette 124 is sent to the transportation path T through a path T2 when a pick-up roller 19A and a roller pair 19B are rotated. The third cassette 126 is located below the second cassette 124 in the Z direction in the additional unit 113. The third cassette 126 has the same configuration as the second cassette 124 except for the position, for example. Thus, the configuration of the third cassette 126 will not be explained.

The ink supplier 130 supplies the ink Q to the line head 140 (described later). The cap portion 132 has a box-like shape opening in the −A direction. The cap portion 132 is reciprocated in the B direction when driven by a drive mechanism (not illustrated). In the maintenance of the line head 140, the cap portion 132 is moved in the +B direction to cover the ejection portion 142 (described later) and then removes the ink Q by suction. The cap portion 132 is moved back in the −B direction to the home position when the line head 140 performs recording.

The wiper portion 134 includes a unit body 136 that stores the ink Q and a wiper blade 137 that is disposed in the unit body 136 and configured to wipe the ink Q from the ejection portion 142. The wiper portion 134 is reciprocated in the X direction when driven by a drive mechanism (not illustrated). In the maintenance of the line head 140, the wiper portion 134 wipes the surface of the ejection portion 142 while being moved in the +X direction to collect the ink Q. The wiper portion 134 is moved back in the -X direction to the home position when the line head 140 performs recording.

The waste liquid tank 138 is located at substantially the center in the Y direction and the Z direction of the main unit 112 and is replaceable. The waste liquid tank 138 collects the ink Q collected at the cap portion 132 and the ink Q collected at the wiper portion 134. The controller (not illustrated) includes a central processing unit (CPU), read-only memory (ROM), random-access memory (RAM), and a storage (not illustrated), to control transportation of the sheet P in the printer 110 and operations of the components including the line head 140.

The line head 140 is located above the paper cassette 116 and the waste liquid tank 138 in the Z direction when positioned at the home position before operation. The line head 140 is an example of the recording portion that makes a record on the sheet P transported from the paper cassette 116 along the transportation path T (described later). The line head 140 is moved in the +A direction and the −A direction when driven by the movement portion 144 (described later). Specifically described, the line head 140 includes a carriage 141 driven by the movement portion 144 and an ejection portion 142 supported by the carriage 141. The ejection portion 142 ejects the ink Q supplied by the ink supplier 130 onto the sheet P.

The movement portion 144 includes, for example, a rack 45, a pinion 46, and a motor (not illustrated). The rack 45 is attached to the bottom surface of the carriage 141 facing in the −Z direction. The rack 45 has teeth (not illustrated). The pinion 46 is rotated in a normal direction or an opposite direction by a motor (not illustrated). The pinion 46 has teeth (not illustrated) engaging the teeth of the rack 45 on the outer surface.

The transportation path T extends from the paper cassette 116 to the output tray 117 and is a path along which the sheet P is transported. On the transportation path T, pick-up rollers 19A, roller pairs 19B, a take-in roller pair 121, roller pairs 123 and 125, a transportation belt 131, a drive roller 133, a driven roller 135, a roller pair 127, and an output roller pair 129 are disposed. The roller pairs are rotated about the axes extending in the X direction. The drive roller 133 and the driven roller 135 are away from each other in the B direction and are rotated about the axes extending in the X direction.

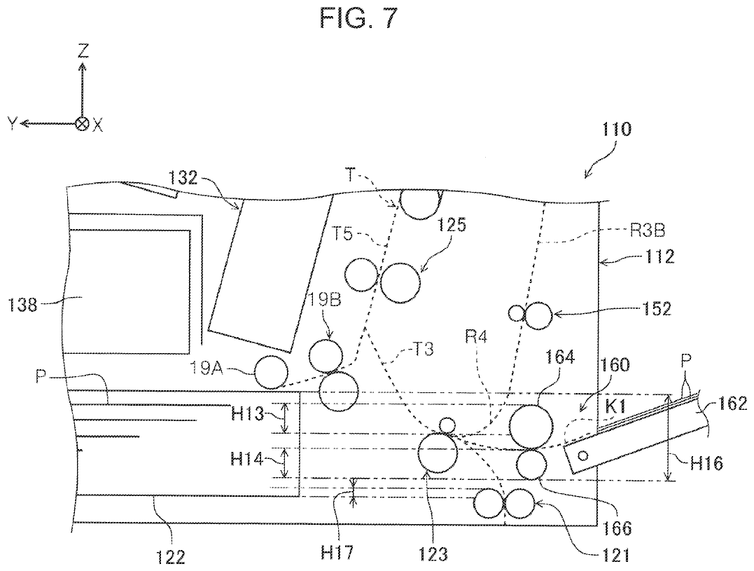

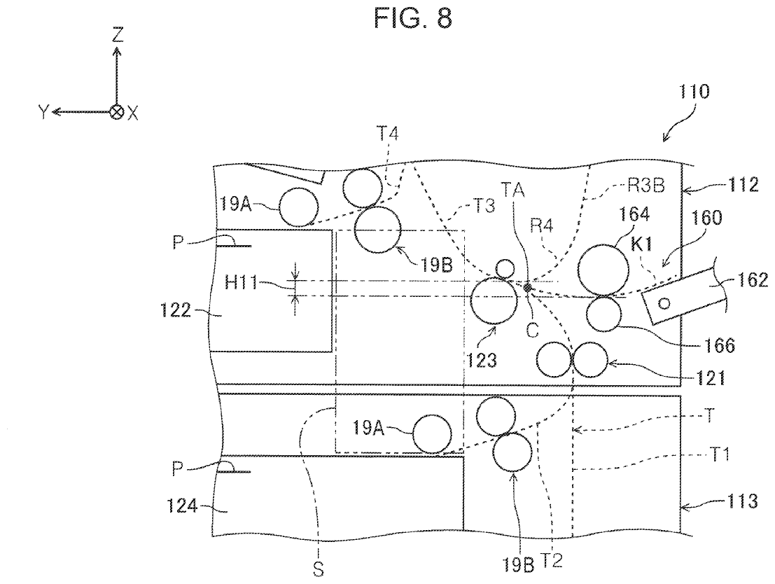

The take-in roller pair 121 is rotatably disposed at the lower end in the Z direction of the main unit 112. The take-in roller pair 121 is an example of a take-in member that takes in the sheet P transported from the additional unit 113. When viewed in the Y direction, a portion of the take-in roller pair 121 and a portion of the first cassette 122 overlap each other over a range defined in the Z direction. The overlap between a portion of the take-in roller pair 121 and a portion of the first cassette 122 extends in a range H17 [mm] (FIG. 7) defined in the Z direction. The range H17 is larger than a range H11 (FIG. 8) (described later) and smaller than the range H14 (FIG. 7), for example.

The transportation belt 131 is wound into a tubular configuration on the drive roller 133 and the driven roller 135. The transportation belt 131 is adjacent to the line head 140 in the +A direction. When the drive roller 133 is rotated by a motor (not illustrated), the transportation belt 131 is rotated. When the transportation belt 131 is rotated, the sheet P on the outer surface of the transportation belt 131 is transported in the +B direction.

Specifically described, the transportation path T includes, for example, a path T1, a path T2, a path T3, a path T4, and a path T5. The path T1 extends from the end in the −Y direction of the third cassette 126 to a nip center N1 of the roller pair 123. The path T2 is an example of a feeding pathway that extends from the end in the −Y direction of the second cassette 124 toward a curved path R4 (described later). The path T2 joins the path T1 at a position upstream of the take-in roller pair 121.

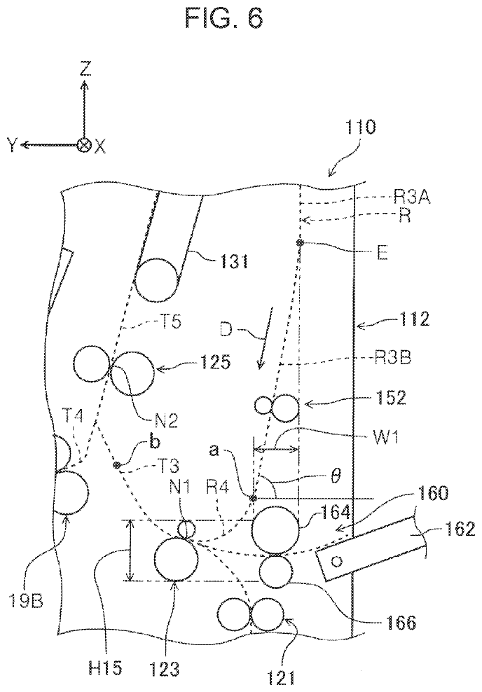

The path T3 extends from the nip center N1 to the nip center N2 of the roller pair 125. The center of the path T3 in the transportation direction is referred to as a position b (FIG. 6). The path T4 extends from the end in the −Y direction of the first cassette 122 to join the path T3. The path T5 extends from the nip center N2 to the nip center N3 of the output roller pair 129 through the transportation belt 131 and the roller pair 127.

The inversion portion 150 includes, for example, an inversion pathway R, four roller pairs 152, and a motor (not illustrated). The inversion portion 150 inverts the sheet P after recording by the line head 140 and then sends the sheet P to the transportation path T again. The inversion pathway R is a pathway including a curved path R4 and coupled to the transportation path T at positions upstream and downstream of the line head 140. The inversion pathway R includes, for example, a branched path R1, a switchback path R2, an upstream path R3, and a curved path R4. The branched path R1 branches from the path T5 at a position away in the +Z direction from the roller pair 127 and extends in the −Y direction and the +Z direction. The switchback path R2 extends from the end in the +Z direction of the branched path R1 in the +Y direction and the +Z direction.

The upstream path R3 is located upstream of the curved path R4 (described later) and downstream of the switchback path R2 in the transportation direction of the sheet P. The upstream path R3 includes, for example, a vertical path portion R3A and a tilted portion R3B. The vertical path portion R3A extends in a straight line from the junction between the branched path R1 and the switchback path R2 in the −Z direction.

As illustrated in FIG. 6, the tilted portion R3B extends in a straight line from a position E, which is the end in the −Z direction of the vertical path portion R3A, in the +Y direction and the −Z direction. In other words, the tilted portion R3B is tilted in an intersecting direction intersecting the Z direction. In FIG. 6, the intersecting direction is indicated by an arrow D. When viewed in the X direction, the tilted portion R3B and the Y direction form an acute angle θ [°]. The angle θ is 75°, for example. The angle θ is preferably not less than 60° and less than 90°, for example. In the main unit 112, a space adjacent to the inversion pathway R in the −Y direction is wider in the Y direction at a position corresponding to the tilted portion R3B.

The curved path R4 is located downstream of the upstream path R3 in the transportation direction of the sheet P. Specifically described, the upstream end of the curved path R4 joins the lower end in the −Z direction of the tilted portion R3B. The coupling position between the tilted portion R3B and the curved path R4 is referred to as a position “a”. The curved path R4 is curved to protrude downward in the Z direction when viewed in the X direction. Furthermore, the curved path R4 joins the path T3 at the nip center N1 of the roller pair 123. In this embodiment, a portion of the path T3 extending from the nip center N1 to the position b is included in the curved path R4, for example. The roller pair 123 is an example of the transportation roller pair on the curved path R4. The sheet P is transported when the roller pair 123 is rotated.

As illustrated in FIG. 7, the input portion 160 includes, for example, an input tray 162, an input roller 164, and a separation roller 166. In this way, the input portion 160 includes an input pathway K1 on which the input roller 164 and the separation roller 166 are disposed. The input portion 160 feeds the sheet P from the input tray 162 through the input pathway K1 to the transportation path T. The input pathway K1 is a pathway extending from the input tray 162 to the transportation path T, coupled to a portion of the transportation path T located upstream of the line head 140 (FIG. 5), and along which the sheet P is transported.

The input tray 162 is rotatably disposed on the −Y direction side of the main unit 112 at a position below the center in the Z direction. The input tray 162 allows multiple sheets P to be placed thereon while being tilted relative to the main unit 112. The input tray 162 is configured to be housed in the main unit 112. A lift-up mechanism (not illustrated) that pushes the sheet P up is disposed between the input tray 162 and the separation roller 166.

The input roller 164 is disposed downstream of the input tray 162 in an input direction of the sheet P along the input pathway K1 and above the input pathway K1. When the input roller 164 is rotated by a motor (not illustrated), the rotating input roller 164 feeds the sheet P to the transportation path T. The separation roller 166 is disposed downstream of the input tray 162 in the input direction of the sheet P along the input pathway K1 and below the input pathway K1. The separation roller 166 is rotated by a motor (not illustrated) in a direction opposite to the rotation direction of the input roller 164. This configuration enables one sheet P at a time to be separated from the other sheets P placed on the input tray 162 and to be fed.

As illustrated in FIG. 8, an area located outwardly from the first cassette 122 in the −Y direction of the Y direction and above the second cassette 124 in the Z direction is referred to as an installation area S. Here, a portion of the curved path R4 is located in the installation area S. The input pathway K1 and the path T2 join together at a position C located upstream of the curved path R4 in the transportation direction of the sheet P and are continuous with the curved path R4. In other words, the input pathway K1 and the path T2 joined together are continuous with the curved path R4.

A portion of the transportation path T where the input pathway K1 and the path T2 join together is referred to as a meeting portion TA. The meeting portion TA is a path portion including the position C and the surrounding portion. Here, when viewed in the Y direction, the meeting portion TA overlaps a portion of the first cassette 122 over a range defined in the Z direction. The overlap between the meeting portion TA and a portion of the first cassette 122 in the Z direction extends, for example, in a range H11 [mm] defined in the Z direction. A portion of the first cassette 122 is a portion of the paper cassette 116.

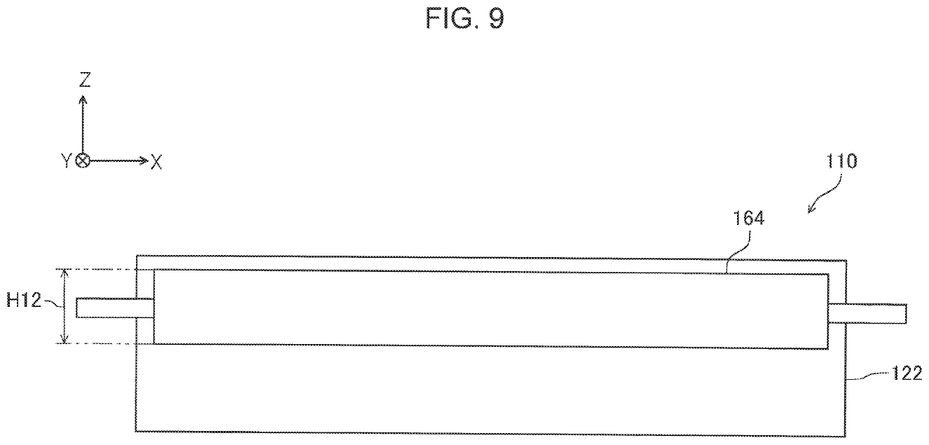

As illustrated in FIG. 9, when viewed in the Y direction, the entire input roller 164 in the Z direction overlaps a portion of the first cassette 122 over a range defined in the Z direction. The overlap between the input roller 164 and the first cassette 122 extends in a range H12 [mm] defined in the Z direction. The range H12 is larger than the range H11 (FIG. 8), for example. In this embodiment, “when viewed in the Y direction” means when an object is viewed in the Y direction from the +Y direction side of the printer 110 toward the −Y direction side. In other words, “when viewed in the Y direction” means when the printer 110 is viewed from the +Y direction side toward the −Y direction side or from the −Y direction side toward the +Y direction side through the side surface, or viewed in side view.

As illustrated in FIG. 7, when viewed in the Y direction, a portion of the input roller 164, a portion of the curved path R4, and a portion of the first cassette 122 overlap each other over a range defined in the Z direction. The overlap between a portion of the input roller 164, a portion of the curved path R4, and a portion of the first cassette 122 extends in a range H13 [mm] defined in the Z direction. The range H13 is larger than the range H11 (FIG. 8) and smaller than the range H12 (FIG. 9), for example.

When viewed in the Y direction, the separation roller 166 and a portion of the first cassette 122 overlap each other over a range defined in the Z direction. The overlap between the separation roller 166 and a portion of the first cassette 122 extends in a range H14 [mm] defined in the Z direction. The range H14 is larger than the range H11 (FIG. 8) and smaller than the range H13, for example.

As illustrated in FIG. 6, when viewed in the Z direction, the tilted portion R3B and the input roller 164, which is a portion of the input portion 160, overlap each other over a range defined in the Y direction. The overlap between the tilted portion R3B and the input roller 164 extends in a range W1 [mm] defined in the Y direction. In this embodiment, “when viewed in the Z direction” means when an object is viewed in the Z direction from the +Z direction side of the printer 110 toward the −Z direction side. In other words, “when viewed in the Z direction” means when the printer 110 is viewed from the +Z direction side toward the −Z direction side through the top surface, or viewed in top view.

When viewed in the Y direction, a portion of the input roller 164, which is a portion of the input portion 160, a portion of the separation roller 166, and the roller pair 123 overlap each other over a range defined in the Z direction. The overlap between a portion of the input roller 164, a portion of the separation roller 166, and the roller pair 123 extends in a range H15 [mm] defined in the Z direction. The range H15 is larger than the range H12 (FIG. 9).

As illustrated in FIG. 7, when viewed in the Y direction, a portion of the input portion 160, a portion of the curved path R4, and a portion of the first cassette 122 overlap each other over a range defined in the Z direction. The overlap between a portion of the input portion 160, a portion of the curved path R4, and a portion of the first cassette 122 extends in a range H16 [mm] defined in the Z direction. The range H16 is larger than the range H15 (FIG. 6).

Next, the operation of the printer 110 will be described. FIGS. 5 to 9 are referred for the components of the printer 110 without identification of the individual figure numbers. For the printer 110, when viewed in the Y direction, a portion of the input portion 160, a portion of the curved path R4, and a portion of the paper cassette 116 overlap each other over a range defined in the Z direction. This configuration requires a smaller installation space for the input portion 160, the curved path R4, and the paper cassette 116 in the Z direction than a configuration in which the input portion 160, the curved path R4, and the paper cassette 116 do not overlap each other, reducing the height of the printer 110 in the Z direction.

The printer 110 requires a smaller installation space for the curved path R4 than a configuration in which the curved path R4 is not located in the installation area S located outwardly from the first cassette 122 in the Y direction and above the second cassette 124 in the Z direction, reducing the height of the printer 110 in the Z direction. For the printer 110, a portion of the input pathway K1 and a portion of the path T2 are combined into one. The printer 110 requires a smaller number of components constituting the transportation path T along which the sheet P is transported than a configuration in which the input pathway K1 and the path T2 separately join the curved path R4.

The printer 110 requires a smaller installation space for the meeting portion TA and the first cassette 122 in the Z direction than a configuration in which the meeting portion TA and the first cassette 122 do not overlap each other, reducing the height of the printer 110 in the Z direction. For the printer 110, when viewed in the Y direction, a portion of the input roller 164, a portion of the curved path R4, and a portion of the paper cassette 116 overlap each other over a range defined in the Z direction. This configuration requires a smaller installation space for the input roller 164, the curved path R4, and the paper cassette 116 in the Z direction than a configuration in which the input roller 164, the curved path R4, and the paper cassette 116 do not overlap each other, reducing the height of the printer 110 in the Z direction.

For the printer 110, the printer 110 has a lower height in the Z direction than a configuration in which the input roller 164 and the paper cassette 116 do not overlap each other over a range defined in the Z direction when viewed in the Y direction. For the printer 110, when viewed in the Y direction, the separation roller 166 and a portion of the paper cassette 116 overlap each other over a range defined in the Z direction. This requires a smaller installation space for the separation roller 166 and the paper cassette 116 in the Z direction than a configuration in which the separation roller 166 and the paper cassette 116 do not overlap each other, reducing the height of the printer 110 in the Z direction.

For the printer 110, the tilted portion R3B of the upstream path R3 provides a space in which a portion of the input portion 160 is disposed, making the width of the printer 110 smaller in the Y direction than a configuration in which the portion of the upstream path R3 extends in the Y direction. For the printer 110, the curved path R4 has the roller pair 123 that transports the sheet P, allowing the sheet P to be more reliably transported along the curved path R4 than a configuration not having the roller pair 123. Furthermore, when viewed in the Y direction, a portion of the input portion 160 and a portion of the roller pair 123 overlap each other in the Z direction, reducing the height of the printer 110 in the Z direction.

The printer 110 according to the second embodiment of the present disclosure basically has the above-described configuration. However, the configuration of the printer 110 may be partly modified or partly omitted without departing from the gist of the present disclosure. The configuration of the second embodiment and the configuration of the first embodiment may be suitably combined.

In the printer 110, when viewed in the Y direction, the entire input portion 160, the entire curved path R4, and the entire paper cassette 116 may overlap each other over a range defined in the Z direction. The entire curved path R4 may be located in the installation area S instead of a portion of the curved path R4. Alternatively, at least a portion of the input portion 160 may be located in the installation area S. Further alternatively, at least a portion of the curved path R4 and at least a portion of the input portion 160 may be located in the installation area S.

In the printer 110, the input pathway K1 and the path T2 may be separately continuous with the curved path R4. When viewed in the Y direction, the meeting portion TA does not need to overlap the first cassette 122 over a range defined in the Z direction. When viewed in the Y direction, at least a portion of the input roller 164, at least a portion of the curved path R4, and at least a portion of the paper cassette 116 may overlap each other over a range defined in the Z direction. Furthermore, the input roller 164 does not need to overlap at least a portion of the curved path R4 and at least a portion of the paper cassette 116 over a range defined in the Z direction. When viewed in the Y direction, only a portion of the input roller 164 in the Z direction may overlap a portion of the paper cassette 116 over a range defined in the Z direction.

In the printer 110, the input portion 160 does not need to have the input tray 162 and the separation roller 166. For example, a sheet P transported from the outside of the printer 110 may be fed along the input pathway K1 to the transportation path T by rotation of the input roller 164. The upstream path R3 does not need to have the tilted portion R3B. Furthermore, when viewed in the Z direction, a portion of the tilted portion R3B and at least a portion of the input portion 160 may overlap each other over a range defined in the Y direction. The curved path R4 does not need to have the roller pair 123. For example, a curved guide member may be disposed, and a sheet P may be guided by the guide member when brought in contact with the guide member. Furthermore, when viewed in the Y direction, at least a portion of the input portion 160 and the entire roller pair 123 may overlap each other over a range defined in the Z direction.

In the printer 110, the movement direction of the line head 140 is not limited to the A direction and may be the Y direction. The paper cassette 116 may include only the first cassette 122 or does not need to include the third cassette 126.

What is claimed is:

1. A recording apparatus comprising:
a recording portion configured to move in a first movement direction having a component of a horizontal direction and a component of an apparatus height direction and configured to eject a liquid onto a medium to make a record; and
a collection portion in which the liquid ejected from the recording portion is collected, wherein
the collection portion is located below the recording portion in the apparatus height direction, and
when viewed in the apparatus height direction from top to bottom, a movement area of the recording portion and at least a portion of the collection portion overlap each other over a range defined in an apparatus width direction intersecting the apparatus height direction.

2. The recording apparatus according to claim 1, further comprising:
a maintenance portion configured to move in a second movement direction intersecting the first movement direction and configured to perform maintenance of the recording portion, wherein
the maintenance portion is located below the recording portion in the apparatus height direction, and
at least a portion of the collection portion overlaps, when viewed in the apparatus width direction, the maintenance portion over a range defined in the apparatus height direction.

3. The recording apparatus according to claim 1, further comprising:
a movement portion configured to move the recording portion in the first movement direction, wherein
at least a portion of the movement portion is located below the movement area and above the collection portion in the apparatus height direction.

4. The recording apparatus according to claim 1, further comprising:
a supplier configured to supply the liquid to the recording portion, wherein
when viewed in the apparatus width direction, at least a portion of the supplier and at least a portion of the collection portion overlap each other over a range defined in the apparatus height direction.

5. The recording apparatus according to claim 4, wherein at least a portion of the supplier overlap, when viewed in the apparatus width direction, at least a portion of the movement area over a range defined in the apparatus height direction.

6. The recording apparatus according to claim 4, further comprising a transportation belt placed opposite to the recording portion and configured to transport the medium, wherein
at least a portion of the transportation belt overlap, when viewed in the apparatus width direction, at least a portion of the supplier over a range defined in the apparatus height direction.

7. The recording apparatus according to claim 1, further comprising:
a receptacle portion configured to receive the medium after recording by the recording portion and extending in the first movement direction, wherein
when viewed in the apparatus height direction from top to bottom, at least a portion of the receptacle portion and at least a portion of the movement area overlap each other over a range defined in the apparatus width direction.

8. The recording apparatus according to claim 1, wherein the collection portion is configured to be detached in an intersecting direction intersecting the apparatus width direction.

9. The recording apparatus according to claim 1, further comprising:
at least one medium storage configured to store a medium;
a transportation path along which the medium is transported from the medium storage to the recording portion;
an inversion portion including an inversion pathway having a curved path that protrudes downward in the apparatus height direction and coupled to the transportation path at positions upstream and downstream of the recording portion, the inversion portion being configured to invert the medium after recording by the recording portion; and
an input portion including an input pathway coupled to a portion of the transportation path located upstream of the recording portion and configured to feed the medium from the input pathway to the transportation path, wherein
when viewed in the apparatus width direction, at least a portion of the input portion, at least a portion of the curved path, and at least a portion of the medium storage overlap each other over a range defined in the apparatus height direction.

10. The recording apparatus according to claim 9, wherein the medium storage includes a first storage having a first length in the apparatus width direction and a second storage located below the first storage in the apparatus height direction and having a second length larger than the first length in the apparatus width direction, and
at least one of at least a portion of the curved path and at least a portion of the input portion is located outwardly from the first storage in the apparatus width direction and above the second storage in the apparatus height direction.

11. The recording apparatus according to claim 10, wherein a feeding pathway extends from the second storage to the curved path,
the input pathway and the feeding pathway joined together are coupled to the curved path, and
a meeting portion where the input pathway and the feeding pathway join together overlaps, when viewed in the apparatus width direction, a portion of the first storage over a range defined in the apparatus height direction.

12. The recording apparatus according to claim 9, wherein the input portion includes an input roller configured to send the medium to the transportation path, and
when viewed in the apparatus width direction, at least a portion of the input roller, at least a portion of the curved path, and at least a portion of the medium storage overlap each other over a range defined in the apparatus height direction.

13. The recording apparatus according to claim 9, wherein the input portion includes an input tray on which multiple sheets of the medium are placed and a separation roller configured to separate one from the multiple sheets of the medium on the input tray, and
when viewed in the apparatus width direction, the separation roller and at least a portion of the medium storage overlap each other over a range defined in the apparatus height direction.

14. The recording apparatus according to claim 9, wherein the inversion portion further includes an upstream path located upstream of the curved path in a transportation direction of the medium,
the upstream path includes a tilted portion tilted in an intersecting direction intersecting the apparatus height direction, and
when viewed in the apparatus height direction from top to bottom, at least a portion of the tilted portion and at least a portion of the input portion overlap each other over a range defined in the apparatus width direction.

15. The recording apparatus according to claim 9, wherein the curved path includes a transportation roller pair configured to transport the medium, and
when viewed in the apparatus width direction, at least a portion of the input portion and at least a portion of the transportation roller pair overlap each other over a range defined in the apparatus height direction.

16. The recording apparatus according to claim 1, wherein the first movement direction and the apparatus width direction form an angle of not less than 10° and not more than 40°.
